(19) United States
(12) Patent Application Publication
(10) Pub. No.: US 2026/0003496 A1
(43) Pub. Date: Jan. 1, 2026

(54) SYSTEM AND METHOD TO PROVIDE ASSISTANCE TO USER VIA A MULTIMODAL MODEL

(71) Applicant: Talent Unlimited Online Services Private Limited, South Delhi (IN)

(72) Inventors: Ankit PRASAD, Jamshedpur (IN); Rahul PRASAD, Gurugram (IN); Kaushik PARASHAR, Guwahati (IN); Sathwik RAO, Surathkal (IN); Kailash Chandra BHATT, Ghaziabad (IN)

(73) Assignee: Talent Unlimited Online Services Private Limited, South Delhi, DL (IN)

(21) Appl. No.: 18/829,550

(22) Filed: Sep. 10, 2024

(30) Foreign Application Priority Data
Jun. 28, 2024 (IN) 202411049753

(51) Int. Cl. G06F 3/04886; G06F 3/0482; G06N 5/02; H04L 51/02; H04L 51/046

(52) U.S. Cl. CPC G06F 3/04886; G06F 3/0482; G06N 5/02; H04L 51/02; H04L 51/046

(57) ABSTRACT

A system (100) and method (800) for an AI keyboard (104) that includes an AI clipboard suggestion interface (114) that receives input from a clipboard of a computing device (102). An AI suggestion bar (112) receives input from typed text in the AI suggestion bar (112) of the computing device (102). The AI keyboard (104) generates an artificial intelligence suggestion by processing an action button prompt through an AI chat server (110) that has been trained with data representative of a user's topic and a user's profile. The AI keyboard (104) provides the processed response, or the predicted content via the network, in a typing box of the AI keyboard (104). The processed response or the predicted content is integrated into the user current conversation session without moving out from a current application interface.

### FIELD OF THE DISCLOSURE

This invention generally relates to a field of a multimodal model for an artificial intelligence assistance and, in particular, relates to a method and a system to provide assistance via a multimodal model to a user as a function of derived user intent.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

An artificial intelligence (AI) keyboard with integrated AI reply feature is programmed machine that can conduct a conversation via multiple modalities such as auditory, image, video, or textual means with a user. Many times, the AI reply may be implemented as a specifically programmed machine using various trained artificial intelligence (AI) networks. Some AI keyboard may be used in various applications.

Many AI keyboard are very fact based, and associate words provided by the user with information from one or more databases in generating a response. Responses generated in this manner may miss elements of communication that are not fact based, resulting in responses that may not be relevant to what a user actually needs.

According to a patent application “U.S. Pat. No. 11,501,763B2” titled “Machine learning tool for navigating a dialogue flow” discloses a system and method for navigating a dialogue flow using a trained intelligence bot. Upon initiation of a chat session between a user and a trained intelligence bot, one or more utterances can be received. The utterances can be processed using the trained intelligence bot to resolve an intent from among a plurality of predefined intents, where the intelligence bot is trained to resolve predefined intents based on training data associated with the predefined intents.

However, there are many AI chat bot present but none of the AI chat bot provide assistance to a user as a function of derived user intent via a multimodal model. Therefore, there is a need for a method and a system to provide assistance to a user as a function of derived user intent via a multimodal model.

### OBJECTIVE OF THE INVENTION

It is an objective of the present invention to provide a system and a method for providing an artificial intelligence assistance to a user as a function of derived user intent via a multimodal model.

It is an objective of the present invention to provide an AI keyboard for a computing device.

It is an objective of the present invention to provide an AI suggestion at least based on a user's intent to generate a processed response or a predicted content on a current conversation topic.

It is an objective of the present invention to provide the processed response or the predicted content via a network, in a typing box of the AI keyboard.

It is an objective of the present invention to provide a versatile AI keyboard that may be integrated to any software application.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

According to an aspect, the present embodiments disclose a method for providing an artificial intelligence assistance to a user as a function of derived user intent via a multimodal model. Further, the method steps include receiving input from an artificial intelligence (AI) keyboard of a computing device of a user and a current conversation session. Further, the method steps include determining a current conversation topic from the current conversation session via a topic detection module. Further, the method steps include generating a plurality of action button prompts on current conversation topic, by processing the current conversation topic through a topic engagement module that has been trained on an AI chat server. Further, the method steps include receiving input of selecting the action button prompt by the user on the AI keyboard. Further, the method steps include generating an artificial intelligence suggestion, by processing the action button prompt through the AI chat server that has been trained with data representative of a user's topic and a user's profile. Further, the method steps include filtering the AI suggestion at least based on the user's intent to generate a processed response or a predicted content on the current conversation topic via a response prediction module. Further, the method steps include providing the processed response or the predicted content via a network, in a typing box of the AI keyboard. The processed response or the predicted content is integrated into the user current conversation session without moving out from a current application interface.

Further, the artificial intelligence (AI) keyboard comprises an AI clipboard suggestion interface, configured to receive input from a clipboard of the computing device. Furthermore, the AI keyboard may comprise an AI suggestion bar, configured to receive input from typed text, not limited to typed text in the AI suggestion bar of the computing device.

Further, the plurality of action button prompts on the AI clipboard suggestion interface may comprise a summary action button prompt, an AI reply action button prompt and a translate action button prompt, to suggest content for the current conversation session on the computing device, at least based on a knowledge graph. Furthermore, the plurality of action button prompts on the AI clipboard suggestion interface may comprise an AI reply tone of the processed response or a predicted content for the current conversation session.

Further, a plurality of action button prompts on the AI suggestion bar may comprise an AI writer action button prompt to suggest content for the current conversation session on the computing device, at least based on a knowledge graph. Further, the plurality of action button prompts on the AI suggestion bar may comprise a plurality of feature action button prompt to generate content for the current conversation session on the computing device.

Further, the AI suggestion is filtered at least based on the user's intent, the AI suggestion may comprise an AI reply tone of the processed response or a predicted content for the current conversation session.

Further, the AI chat server is configured to receive input from multiple users involved in the current conversation session. The AI chat server may correlate each processed response or the predicted content of each user and generate a knowledge graph of the current conversation session and train the AI chat server in real-time based a database and the user profile.

According to an aspect, the present embodiments disclose a system to provide assistance to a user as a function of derived user intent via a multimodal model, Further, the system comprise a processing unit and a memory. The memory comprising instructions, which when executed by the processing unit, cause the processor to perform operations for providing information to a user as a function of derived user intent. The operation steps include receiving input from an artificial intelligence (AI) keyboard of a computing device of a user and a current conversation session. Further, the operation steps include determining a current conversation topic from the current conversation session via a topic detection module. Further, the operation steps include generating a plurality of action button prompts on current conversation topic, by processing the current conversation topic through a topic engagement module that has been trained on the AI chat server. Further, the operation steps include receiving input of selecting the action button prompt by the user on the AI keyboard. Further, the operation steps include generating an artificial intelligence suggestion, by processing the action button prompt through an AI chat server that has been trained with data representative of a user's topic and a user's profile. Further, the operation steps include filtering the AI suggestion at least based on the user's intent to generate a processed response or a predicted content on the current conversation topic via a response prediction module. Further, the operation steps include providing the processed response or the predicted content via the network, in a typing box of the AI keyboard. The processed response or the predicted content is integrated into the user current conversation session without moving out from a current application interface.

It should be appreciated that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF DRAWINGS

The accompanying drawings illustrate various embodiments of systems, methods, and embodiments of various other aspects of the disclosure. Any person with ordinary skills in the art will appreciate that the illustrated element boundaries 30 (e.g. boxes, groups of boxes, or other shapes) in the figures represent one example 6 of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIGS. 1A & 1B illustrates, a system (100) to provide assistance to a user as a function of derived user intent via a multimodal model, according to an embodiment.

FIG. 2 illustrates, a block diagram illustrating physical components (e.g., hardware) of a computing device (102), according to an embodiment.

FIG. 3 illustrates, an architecture of the system (100) for processing data received from the computing device (102) on a network (106), via an AI chat server (110), according to an embodiment.

FIG. 4 illustrates, a block diagram of an AI clipboard suggestion interface (114), according to an embodiment.

FIGS. 5A-P illustrates, a current conversation session for the AI clipboard suggestion interface (114), according to an embodiment.

FIGS. 6A & 6B illustrates, a block diagram of an AI suggestion bar (112), according to an embodiment.

FIGS. 7A-H illustrates, the current conversation session for the AI suggestion bar (112), according to an embodiment.

FIG. 8 illustrates, a flowchart illustrating operations for providing assistance to a user as a function of derived user intent via a multimodal model, according to an embodiment.

### DETAIL DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

An artificial intelligence (AI) based suggestions for reply and content generation, are becoming more and more prevalent and are being utilized for more and more different tasks. The AI based suggestions may be integrated into the software applications such as a keyboard and a clipboard of a computing device. As understood by those skilled in the art, an AI keyboard are software applications that may run automated tasks over a network, such as the Internet. The AI keyboard is designed to provide an AI suggestion at least based on the current conversation session via an AI chat server. The AI chat server may utilize sophisticated natural language processing systems for keywords from a user input and then generate a reply with the most relevant content for the current conversation session.

As such, a system and a method as disclosed herein to provide assistance to a user as a function of derived a user intent via a multimodal model for one or more users. The system utilizes the network with the AI chat server to identify topics, generate action button prompt and the AI reply for the user on the current conversation session. Further, the system updates the database and create a knowledge graph at least based on a user profile.

In some aspects, the system utilizes user knowledge graph to train and update the learning algorithms and/or models of the AI chat server to provide assistance to a user as a function of derived a user intent. Furthermore, the knowledge graph for every user is different that is based on the user profile.

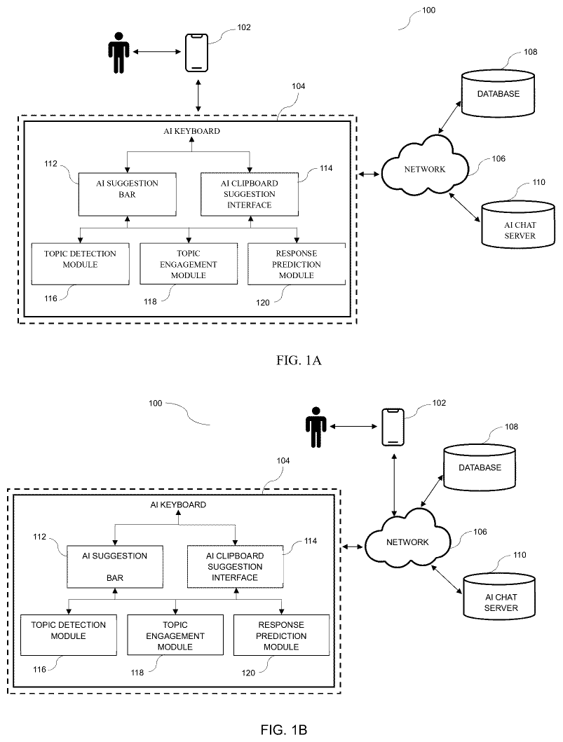

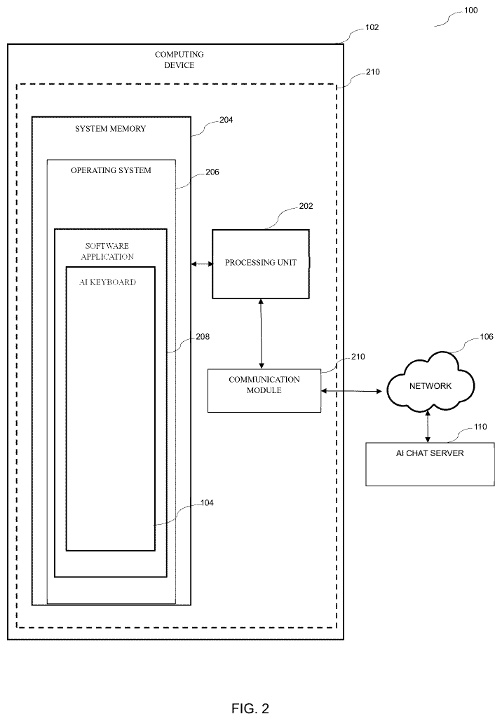

Referring to FIGS. 1A & 1B, a system (100) to provide assistance to a user as a function of derived user intent via a multimodal model, according to an embodiment. In one embodiment, the system (100) may comprise a computing device (102) with an AI keyboard (104), a network (106), a database (108) and an AI chat server (110). Further, the computing device (102) may be used by the user to communicate with the AI chat server (110), that is connected to the network (106). The computing device (102) may be a mobile telephone, a smart phone, a tablet, a phablet, a smart watch, a wearable computer, a personal computer, a gaming system, a desktop computer, a laptop computer, and/or etc that may use a keyboard for an input of the user. This list is exemplary only and should not be considered as limiting. Any suitable client computing device (102) for implementing the AI keyboard (104) for communicating with the AI chat server (110).

In some aspects, the system (100) may comprise the AI keyboard (104) directly on the computing device (102) as illustrated by FIG. 1A. In a basic configuration, the computing device (102) is a computer having both input elements and output elements. The computing device (102) is configured to run the AI keyboard (104) application for the user as the input element.

In other aspects, the AI keyboard (104) is implemented on the network (106) to provide a virtual keyboard for the computing device (102), as illustrated in FIG. 1B. The AI keyboard (104) may provide data to and/or receive data from the computing device (102) through the network (106). Further, the AI keyboard (104) may be implemented on more than one server in the network (106). For example, a company may run the AI keyboard (104) on a separate server within the organisation.

In some aspects, the AI keyboard (104) may run on a hybrid system (not shown) with some features in the AI keyboard (104) on the computing device (102) and with some features in the AI keyboard (104) on one or more network (106) connecting the user via the computing device (102).

In an embodiment, the AI keyboard (104) may comprise an AI suggestion bar (112) and an AI clipboard suggestion interface (114). The AI suggestion bar (112) is embedded/integrated with the AI keyboard (104), to provide AI generated content at least based on an input by the user on the current conversation session. Further, the AI suggestion bar (112) is configured to analyse a topic at least based on the input from the user via a topic detection module (116). The topic detection module (116) may be electronically connected in conjunction with the AI chat server (110). The topic detection model (116) analyses the user input or collection to determine one or more topics in the current conversation session between at least two users via there computing device (102). The topic detection module (116) may selectively pick parser to parse sentences in the current conversation session such as verbs, noun and object in the sentence. The topic detection module (116) may transfer the segregated user input to the AI chat server (110). The AI chat server (110) is configured to determine an existing topic in the database (108) having a similar dependency parsing as the current conversation session.

The topic detection module (116) may prioritise the recent determined topic at least based on the current conversation session. For example, the determined topic does not meet a timing of the current conversation session, the topic detection module (116) removes the filtered topic from the current conversation session. However, these timing of the current conversation session are exemplary and are not meant to be limiting.

Further, the determined topic of the current conversation session is analysed with the existing topic in the database (108) to generate a plurality of action button prompts on current conversation topic. The plurality of action button prompts may be generated by processing the current conversation topic through a topic engagement module (118) that has been trained on the AI chat server (110). The topic engagement module (118) generates the plurality of action button prompts for each topic that represents how often and how recently a topic is discussed or engaged in by the one or more user in the current conversation session.

In some aspects, the topic engagement module (118) may utilize a learning algorithm or model based on the user profile and a previous search history via the keyboard (104) of the computing device (102). The output of the topic engagement module (118) may links each determined topic to any user engaged in (or provides input that relates to) that determined topic based on the number of engaged users or users linked to the topic, frequency of the topic (how many times the topic is discussed in the conversation), timing of the topic (or how recently the topic was discussed by one or more users). Furthermore, the plurality of action button prompts may be displayed on the AI keyboard (104) for the user. The user is configured to select at least one action button prompt as the input via the AI keyboard (104) for the AI chat server (110).

The AI chat server (110) may generate an AI suggestion. The AI suggestion via the AI chat server (110) may be based on a data representative of the user's topic and the user's profile. It may be noted that the AI chat server may store the previous conversation data to create a knowledge curve for the user profile. Further, a response prediction module (120) may be configured to filter the AI suggestion generated via the AI chat server (110) at least based on the user's intent to generate a processed response or a predicted content on the current conversation topic via the AI chat server. For example, the user intent may be casual, formal, and witty. Thus, the user may be configured to request modified AI suggestion as casual, formal, and witty. The response prediction module (120) may provide the processed response or the predicted content via the network (106), in a typing box (not shown) of the AI keyboard (104).

Further, the processed response or the predicted content may be integrated into the user current conversation session without moving out from a current application interface. The user may share the processed response or the predicted content on the current conversation session. It may be noted that the processed response or the predicted content may contain a text message, an emoji, a link, an image, an audio or a video, related to the current conversation session.

In some aspects, the AI clipboard suggestion interface (114) may be analogous to the AI suggestion bar (112). It may be noted that the aspects related to the AI clipboard suggestion interface (114) may be similar to the AI suggestion bar (112).

Referring to FIG. 2, is a block diagram illustrating physical components (e.g., hardware) of the computing device (102) with which aspects of the disclosure may be practiced. For example, the AI keyboard (104) could be implemented by the computing device (102). In some aspects, the computing device components described below may include computer executable instructions for the AI keyboard (104) that can be executed to employ the AI suggestion. In a basic configuration, the computing device (102) may include at least one processing unit (202) and a system memory (204). Depending on the configuration and type of computing device (102), the system memory (204) may comprise, but is not limited to, volatile storage (e.g., random access memory), non-volatile storage (e.g., read-only memory), flash memory, or any combined of such memories.

In some aspects, the system memory (204) may include volatile and non-volatile, removable and non-removable media implemented in any method or technology for storage of information, such as computer readable instructions, data structures, or program modules. The system memory (204) may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device (102). Any such system memory (204) may be part of the computing device (102). The system memory (204) does not include a carrier wave or other propagated or modulated data signal.

The computing device (102) may run an operating system (206) at least based on the instruction stored in the system memory (204), via the processing unit (202). The operating system (206) may comprise one or more program application suitable for running a software application (208). The operating system (206), for example, may be suitable for controlling the operation of the computing device (102). Furthermore, aspects of the disclosure may be practiced in conjunction with a graphics library, other operating systems, or any other application program and is not limited to any particular application or system. This basic configuration is illustrated in FIG. 2 by those components within a dashed line (210). The computing device (102) may have additional features or functionality. For example, the computing device (102) may also include additional data storage devices (removable and/or non-removable) such as, for example, magnetic disks, optical disks, or tape.

As stated above, the processing unit (202) may run the AI keyboard (104) in the software application (208) of the operating system (206), that include the AI suggestion bar (112) and AI clipboard suggestion interface (114). It may be noted that the computing device (102) of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 2 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device (102) on the single integrated circuit (chip).

Aspects, of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

As stated above, the software application (208) and data files may be stored in the system memory (204). Furthermore, the operating system (206) may include the software application (208) that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc. In some aspect, the AI keyboard (104) allows a user to interact with in one or more of the above referenced applications in more effective, more efficient, and improved manner.

Further, the software application (208) may receive the input from the AI keyboard (104). The AI keyboard (104) may be configured to show customised plurality of action buttons to increase the interaction of the user on that software application (208). Further, the output of the AI suggestion from the AI keyboard (104) may be displayed in the test box of such software applicant (208). The aforementioned devices are examples and others may be used. Further, the computing device (102) may include one or more communication connections (212) allowing communications with other computing devices (102). Examples of suitable communication connections (212) include, but are not limited to, RF transmitter, receiver, and/or transceiver circuitry, universal serial bus (USB), parallel, and/or serial ports. The communication connections (212) may generate a link for the computing device (102) to communicate with the network (106). The network (106) may communicate with the AI chat server (110) to provide AI generated suggestion for the user.

Further, the communication module (210) may be embodied with the processing unit (202) to communicate computer readable instructions, data structures, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

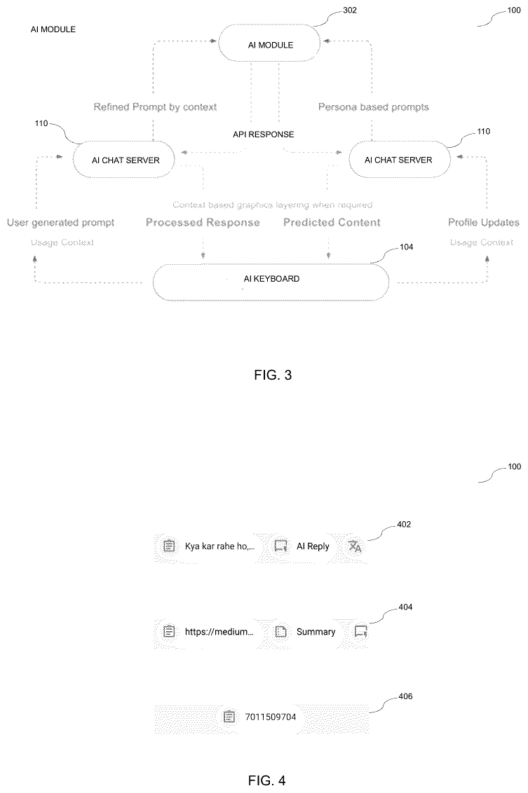

Referring to FIG. 3, an architecture of the system (100) for processing data received from the computing device (102) on the network (106), via the AI chat server (110), according to an embodiment. The AI keyboard (104) may be configured to receive collect a user profile information and the current conversation session. The user profile information may be used by the AI chat server (110) to a generate knowledge graph by implementing a plurality of training modules in an artificial intelligence module (302). As, the computing device (102) receive the input from the user via the AI keyboard (104). The user input may be in the form of user generated prompt. The AI chat server (110) may utilize the topic detection module (116) and the topic engagement module (118) to refine the user prompt. Further, the trained AI module (302) may generate the plurality of action buttons for the user. Further, the AI module (302) may be configured to generate AI generated reply for the selected user action button. It may be noted that the AI generated reply may be in the form of API response. The AI generated reply may be communicated the computing device (102) via the AI chat server on the network (106). In some aspects, the AI generated reply may be a processed response or a predicted content, at least based on selected user prompt. The response prediction module (120) is configured to display the AI generated reply from the AI chat server (110). For example, the AI keyboard (104) may be integrated into a web portal, a mailbox service, instant messaging applications, and/or a social networking site. In some aspects, the keyboard of the application may be replaced with the AI keyboard (104).

Referring to FIG. 4, a block diagram of the AI clipboard suggestion interface (114). In some aspects, the AI clipboard suggestion interface (114) may comprise the AI chat server (110) defined parameters such as a text font and color (Dark/Light), an icon (Dark/Light), a button color stroke (Dark/Light) and the action button (call to action prompt). In first aspect, the action button for a text (402) such as in on going current conversation session may be represented with an AI reply, a translate and a summary, for the user to generate the AI response from the AI chat server (110). In second aspect, the action button for a link (404) such as in on going current conversation session may be represented with an AI reply, a translate and a summary, for the user to generate the AI response from the AI chat server (110). In third aspect, the action button for a number (406) such as in on going current conversation session may not generated for the user.

Further, the generated text in the AI clipboard suggestion interface (114) is copied, it displays on the keyboard with action buttons, on the same session. The AI keyboard (104) is open in the text box of a chat and the user switches between keyboard home & clipboard, it is counted as the same session. The clipboard bar persists while typing. It may be noted that the length of the AI suggestion on the top bar should be at least twenty characters with no limit on the copied text to be sent to the AI chat server (110).

In first aspect, the AI reply action button for the text (402) generate an AI reply for the copied text. It may be noted that by tapping on the AI reply action button may be configured to collapse/expand the box. After, the AI reply is generated, a plurality of sub action buttons is generated that may be visible below the reply namely such as a send, a regenerate, a professional, and a creative action button. It may be noted that by tapping on the regenerate action button is configured to regenerate the AI reply output and the current reply would be saved on the client end to be accessible via sub action buttons such as Last Reply 1, Last Reply 2, last Reply 3, etc. For example, if the last reply sub action button is taped the AI keyboard (104) would fetch the client-saved reply and display it in the text box. In some aspects, the AI keyboard (104) may not be able to communicate with the AI chat server (110) via the network (106). Thus, a server configurable error screen may be display in the text bow of the AI keyboard (104). Further, the server configurable error screen may display anyone one of the following texts in case of an error.
505: Servers on Vacation. Back soon.
404: Code got shy. Coaxing it back!
503: Tech break. Be back shortly!
Oops! Lost in code land. Fixing now!
500 Spa Day: Servers relaxing. Back soon.

In first aspect, the translate action button for the text (402) generate a translation of the copied text. It may be noted that by tapping on the translate action button, automatically translate the copied text to English and input the result in the text box. Further, the translate action button may be configured to translate a plurality of languages from the AI chat server (110) configurable list such as English, Hindi, Bengali, Marathi, Telugu, Tamil, Gujarati, Urdu, Kannada, Odia, Malayalam, Punjabi, Assamese, Maithili, Kashmiri, Nepali, Sindhi and any other available languages. Further, the translate action button may include a separate sub action button for a deep link of the translate action button.

In first aspect, the summary action button for the text (402) generates a summary of the copied text. It may be noted that by tapping on the summary action button, automatically generate a summary in at least fifty words of the copied text in the text box.

Further, the second aspect, the action button for a link (404) such as in on going current conversation session may be analogues to, the first aspect w.r.t the action button for the text (402) represented with an AI reply, a translate and a summary.

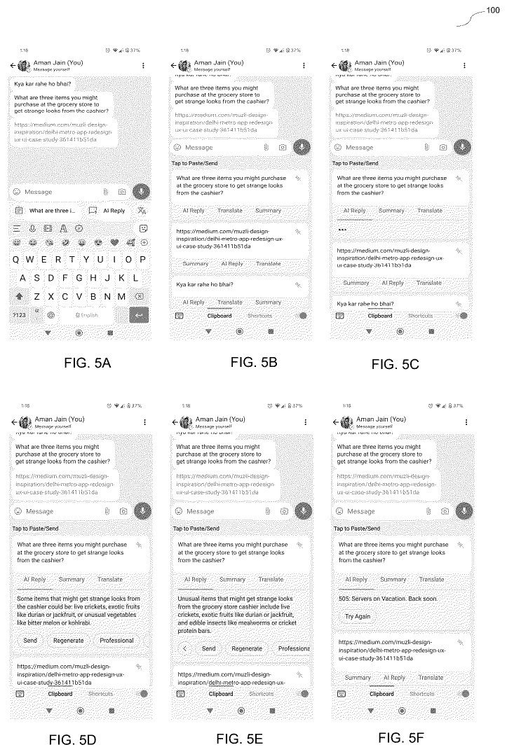

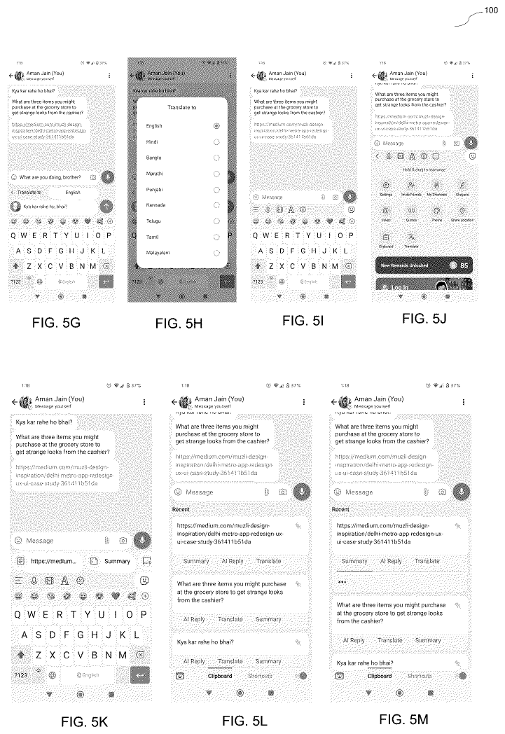

Referring to FIGS. 5A-P, the current conversation session for the AI clipboard suggestion interface (114). For example, the AI keyboard (104) may receive the current conversation session as the input, as shown in FIG. 5A. The detection module (116) may segregate the topic from the current conversation session for which the AI reply is required by the user. Further, the topic engagement module (118) may display the plurality of action buttons such as the AI reply action button, the translate action button and the summary action button, as shown in FIG. 5B. Furthermore, the user may select at least one action button such as the AI reply action button, the translate action button and the summary action button, as shown in FIG. 5C. The user input may be communicated to the AI chat server (110) via the network (106). The AI chat server (110) generate a personalised AI reply, the translation or the summary, at least based on the user knowledge graph by the AI chat server (110). Further, the AI keyboard (104) may display the processed response or a predicted content on the current conversation topic via the AI chat server, as shown in FIG. 5D. It may be noted that, the user may be configured to request modified AI suggestion from the plurality of sub action buttons such as a send action button, a regenerate action button, a professional action button or last reply etc, as shown in FIG. 5E. If the AI keyboard (104) is not able to communicate with the AI chat server (110), may display the server configurable error as shown in FIG. 5F.

In another example, the user may select the translate action button for the current conversation topic. The user input may be communicated to the AI chat server (110) via the network (106). The AI chat server (110) generate the translation, at least based on the user knowledge graph by the AI chat server (110). Further, the AI keyboard (104) may display the processed response or a predicted content on the current conversation topic via the AI chat server (110), as shown in FIG. 5G. It may be noted that, the user may be configured to select the translation language, as shown in FIG. 5H. Further, the user may go to the current conversation session by tapping a back button, as shown in FIG. 5I. Further, the AI keyboard (104) may generate a deep link for the translate UI as shown in FIG. 5J.

In another example, the user may select the summary action button for the current conversation topic, as shown in FIG. 5K. The AI keyboard (104) may generate the plurality of action buttons at least based on the current conversation of the user, as shown in FIG. 5L. The user input may be communicated to the AI chat server (110) via the network (106). The AI chat server (110) generate the summary, at least based on the user knowledge graph by the AI chat server (110), as shown in FIG. 5M. Further, the AI keyboard (104) may display the processed response or a predicted content on the current conversation topic via the AI chat server (110), as shown in FIG. 5N. It may be noted that, the user may be configured to request modified AI suggestion from the plurality of sub action buttons such as a send action button, a regenerate action button, a professional action button or last reply etc, as shown in FIG. 5O. If the AI keyboard (104) is not able to communicate with the AI chat server (110), may display the server configurable error as shown in FIG. 5P.

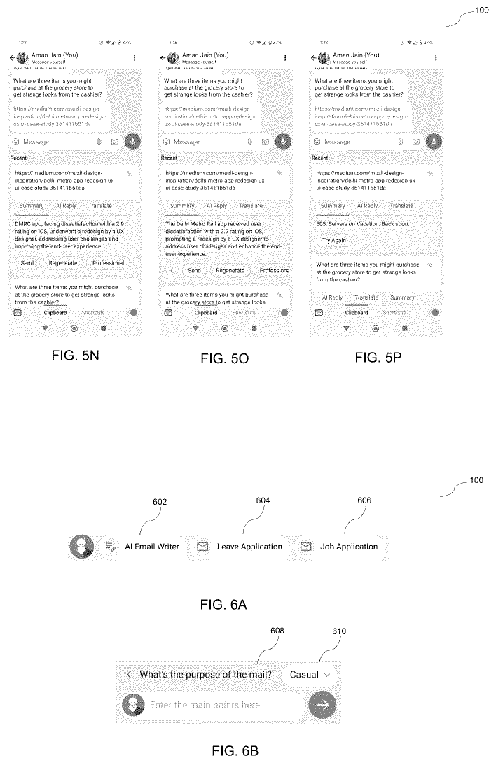

Referring to FIGS. 6A & 6B, a block diagram of the AI suggestion bar (112). In some aspects, the AI suggestion bar (112) may comprise AI chat server (110) defined parameters that are application specific. For example, the action button on a Gmail may be an AI Email Writer action button (602), a Leave Application action button (604) and a Job Application action button (606), etc. and the action button on a LinkedIn may be a Write Article action button, a Looking for Job action button, etc. Further, the AI suggestion bar (112) may comprise a text box (as bar height) in background color (Dark/Light), a left logo may be in JPG/WebP/PNG/GIF that is visibility function to turn On/Off, the action buttons (call to action prompt or the deep link) and a placeholder text & dropdown list for the text box, corresponding to each action button which are server configurable. For example, after the selection at least one of the action buttons in the AI suggestion bar (112) may display the action prompt, as shown in FIG. 6B. The AI Email Writer action button (602) may comprise What's the purpose of the mail? (608)/Enter the main points here, and Write a mail for the subject “I'm late” up to 100 words etc. In another example, the Leave Application action button (604) may comprise What's the reason for leave?/Type the reason here and Write a leave application for the reason “sick” up to 100 words etc. In another example, the Job Application action button (606) may comprise What's the Job Title?/Enter details here and Write a job application for the post of “Graphic Designer” up to 100 words etc. Further, the AI suggestion bar (112) may comprise an icon (608) for selecting the tone such as casual, formal and witty etc.

In some aspects, the AI suggestion bar (112) for example in LinkedIn may comprise a create post action button prompt such as an AI Post Writer, a Job Hiring Post, a Looking for Job and a Motivational Post etc. For example, in Twitter may comprise a create tweet action button prompt such as an AI Tweet Writer, a Funny Tweet, a Motivational Tweet etc. For example, in Facebook may comprise a create post action button prompt such as an AI Tweet Writer, a Funny Tweet, a Motivational Tweet etc.

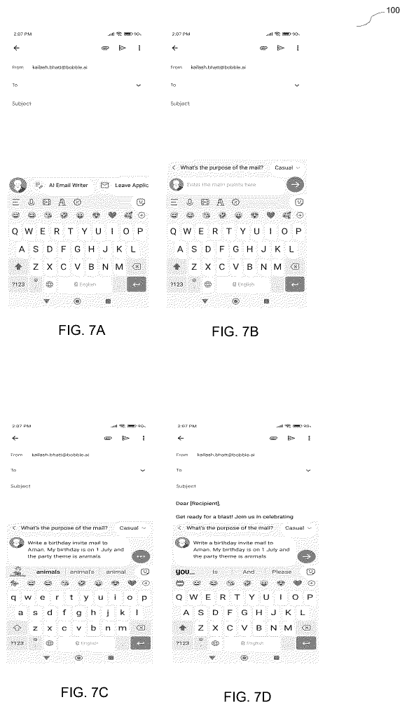

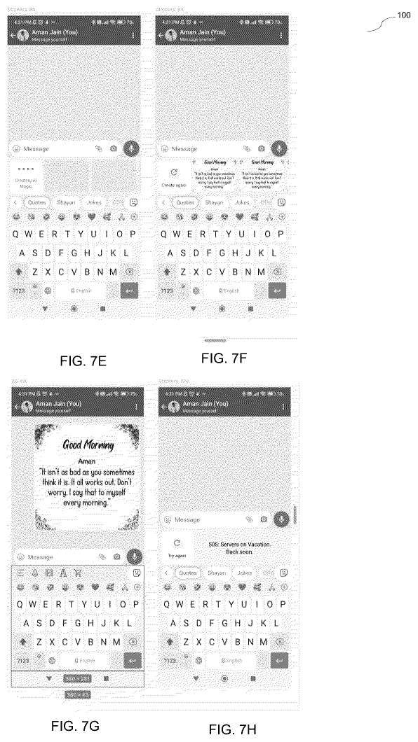

Referring to FIGS. 7A-H, the current conversation session for the AI suggestion bar (112), according to an embodiment. For example, the AI keyboard (104) may suggest the plurality of action button as a prompt for the topic from the current conversation session, via the topic detection module (116). Further, the topic engagement module (118) may display the plurality of action buttons such as the AI Email Writer action button, the Leave Application action button, as shown in FIG. 7A. Further, the AI suggestion bar (112) may display a sub action button bar in the text box as What's the purpose of the mail? At least based on the user selected action button, as shown in FIG. 7B. Further, the user may provide a prompt (such as write a birthday invite mail to Aman. My birthday is on 1 July and the party theme is animals) to generate the AI reply, as shown in FIG. 7C. Further, the AI suggestion bar (112) in communication with the AI chat server (110) generate the AI reply at least based on the knowledge graph based on the user profile. The AI keyboard (104) may display the processed response or a predicted content on the current conversation topic via the AI chat server (110), as shown in FIG. 7D.

In some aspects, the topic engagement module (118) may display the plurality of action buttons such as a quote action button, a joke action button, etc. as shown in FIG. 7E. Further, the AI keyboard (104) may display the processed response or a predicted content on the selected action button via the AI chat server (110). Further, the AI suggestion bar (112) may display a plurality of images in the text box of the selected action button, such as a good morning quotation sticker customised with user name or a good morning GIF customised with user name, as shown in FIG. 7F. Further, the user may send the generated image in the conversation section as shown in FIG. 7G. If the AI keyboard (104) is not able to communicate with the AI chat server (110), may display the server configurable error as shown in FIG. 7H.

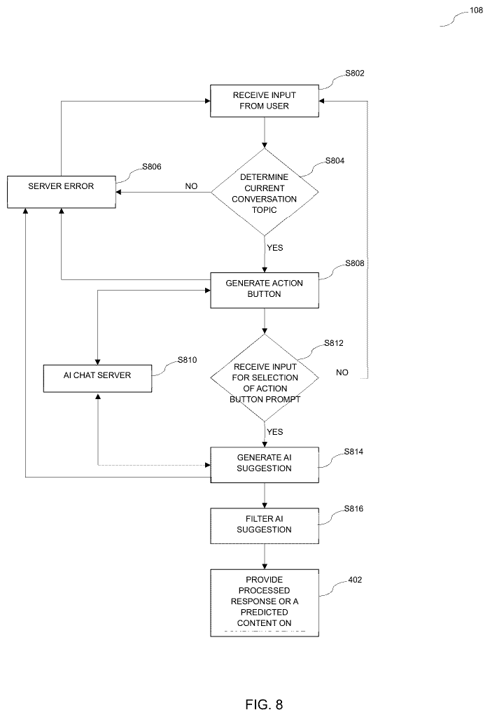

Referring to FIG. 8, a flowchart illustrating a method (800) operations for providing assistance to a user as a function of derived user intent via a multimodal model, according to an embodiment. The method (800) comprising steps of receiving input from the AI keyboard (104) of the computing device (102) of the user and the current conversation session, at step S802. Further, the AI keyboard (104) may receive input from the AI clipboard suggestion interface (114), configured to receive input from a clipboard of the computing device (102) and the AI suggestion bar (112), configured to receive input from typed text in the AI suggestion bar (112) of the computing device (102).

The method (800) comprising steps of determining the current conversation topic from the current conversation session via the topic detection module (116), at step S804. It may be noted that if the current conversation topic is not determined the AI keyboard (104) may display a server error (S806) in the text box.

The method (800) comprising steps of generating the plurality of action button prompts on current conversation topic, by processing the current conversation topic through the topic engagement module (118) that has been trained on the AI chat server (110), at step S808. Further, the action buttons via the AI chat server (110) may be generated at least based on the knowledge graph of the user profile, at step S810.

The method (800) comprising steps of receiving input of selecting the action button prompt by the user on the AI keyboard (104), at step S812. It may be noted that if the input is not received for the user on any action buttons of the current conversation topic. The AI keyboard (104) may re-start the conversation.

The method (800) comprising steps of generating an artificial intelligence suggestion, by processing the action button prompt through the AI chat server (110) that has been trained with data representative of a user's topic and a user's profile, at step S814.

The method (800) comprising steps of filtering the AI suggestion at least based on the user's intent to generate a processed response or a predicted content on the current conversation topic via the response prediction module (120), at step S816. The AI suggestion may be filtered at least based on the knowledge graph of the user profile. Further, the AI suggestion may be filtered at least based on the user's intent.

The method (800) comprising steps of providing the processed response or the predicted content via the network (106), in a typing box of the AI keyboard (104), at step S818. Further, an AI reply tone of the processed response or a predicted content for the current conversation session. Further, the processed response or the predicted content is integrated into the user current conversation session without moving out from a current application interface.

It may be noted that the AI chat server (110) is configured to receive input from multiple users involved in the current conversation session. The AI chat server (110) further comprising correlating each processed response or the predicted content of each user, and generate a knowledge graph of the current conversation session and train the AI chat server (110) in real-time based a database (108) and the user profile.

The AI keyboard (104) may be integrated into a customer message or chat systems, utilizing the AI-powered clipboard for efficient responses and language translation, summarization, improving customer interactions, Further, the AI keyboard (104) require multilingual interfaces, providing users with seamless language translation capabilities. Further, the AI keyboard (104) may be integrated into email platforms for improved mail writing suggestions, summarization of lengthy emails, and language translation for global communication, Collaboration with social media platforms to improve post generation, reply to suggestions, and language translation, enhancing user engagement. Further, the AI keyboard (104) may be integrated into a smart assistant application to provide advanced language generation capabilities, improving user interaction and responsiveness. Further, the AI keyboard (104) may be integrated into a note-taking apps for improved summarization, language translation, and content generation, catering to users in various fields.

The AI keyboard (104) is not limited to a certain software application but may be integrated into a learning application to providing students with advanced language translation and summarization features for improved learning experiences, a Multinational Corporation with diverse teams and global operations may use the technology to facilitate seamless communication among employees who speak different languages, improving collaboration and productivity, an E-commerce Giants dealing with a vast customer base may employ the technology to enhance customer communication, generate product descriptions efficiently, and provide language support for a diverse customer demographic, a Social Media Networks may integrate the technology to improve post generation, a Smart Assistant Providers to enhance language generation capabilities, making the interaction with these assistants more intelligent and context-aware and a Healthcare Technology Firms to leverage the summarization capabilities for efficient documentation, and the language translation feature may aid in communication with a diverse patient population.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific embodiments disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various embodiments disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

What is claimed:

1. A method (800) for providing assistance to a user as a function of derived user intent via a multimodal model, the method (800) comprising:
receiving input from keyboard (104) of a computing device (102) of the user and a current conversation session;
determining a current conversation topic from the current conversation session via a topic detection module (116);
generating a plurality of action button prompts on current conversation topic, by processing the current conversation topic through a topic engagement module (118) that has been trained on the AI chat server (110);
receiving input of selecting the action button prompt by the user on the keyboard (104);
generating an artificial intelligence suggestion, by processing the action button prompt through multimodal model running on device or server (110);
filtering the AI suggestion at least based on the user's intent to generate a processed response or a predicted content on the current conversation topic via a response prediction module (120); and
providing the processed response or the predicted content via the network, in a typing box of the AI keyboard (104),
wherein the processed response or the predicted content is integrated into the user current conversation session without moving out from a current application interface.

2. The method (800) as claimed in claim 1, wherein
the AI keyboard (104) further comprising:
an AI clipboard suggestion interface (114), configured to receive input from a clipboard of the computing device (102); and
an AI suggestion bar (112), configured to receive input from typed text in the AI suggestion bar (112) of the computing device (102).

3. The method (800) as claimed in claim 2, wherein
a plurality of action button prompts on the AI clipboard suggestion interface (114) further comprising:
a summary action button prompt, an AI reply action button prompt and a translate action button prompt, to suggest content for the current conversation session on the computing device (102), at least based on a knowledge graph; and
an AI reply tone of the processed response or a predicted content for the current conversation session.

4. The method (800) as claimed in claim 2, wherein
a plurality of action button prompts on the AI suggestion bar (112) further comprising:
an AI writer email action button (602), a leave application action button (604) and a job application action button (606) prompt to suggest content for the current conversation session on the computing device (102), at least based on a knowledge graph; and
a plurality of feature action button prompt to generate content for the current conversation session on the computing device (102).

5. The method (800) as claimed in claim 1, wherein the AI suggestion is filtered at least based on the user's intent, the AI suggestion further comprising:
an AI reply tone of the processed response or a predicted content for the current conversation session.

6. The method (800) as claimed in claim 1, wherein
the AI chat server (110) is configured to receive input from multiple users involved in the current conversation session, the AI chat server (110) further comprising:
correlating each processed response or the predicted content of each user; and
generate a knowledge graph of the current conversation session and train the AI chat server in real-time based a database (108) and the user profile.

7. A system (100) to provide assistance to a user as a function of derived user intent via a multimodal model, comprising:
a processing unit (202); and
a system memory (204), the system memory (204) comprising instructions, which when executed by the processing unit (202), cause the processing unit (202) to perform operations for providing information to a user as a function of derived user intent, the operations comprising:
receiving input from an artificial intelligence (AI) keyboard (104) of a computing device (102) of the user and a current conversation session;
determining a current conversation topic from the current conversation session via a topic detection module (116);
generating a plurality of action button prompts on current conversation topic, by processing the current conversation topic through a topic engagement module (118) that has been trained on the AI chat server (110);
receiving input of selecting the action button prompt by the user on the AI keyboard (104);
generating an artificial intelligence suggestion, by processing the action button prompt through an AI chat server (110) that has been trained with data representative of a user's topic and a user's profile;
filtering the AI suggestion at least based on the user's intent to generate a processed response or a predicted content on the current conversation topic via a response prediction module (120); and
providing the processed response or the predicted content via the network, in a typing box of the AI keyboard (104),
wherein the processed response or the predicted content is integrated into the user current conversation session without moving out from a current application interface.

8. The system (100) as claimed in claim 7, wherein
the AI keyboard (104) further comprising:
an AI clipboard suggestion interface (114), configured to receive input from a clipboard of the computing device (102); and
an AI suggestion bar (112), configured to receive input from typed text in the AI suggestion bar (112) of the computing device (102).

9. The system (100) as claimed in claim 8, wherein
a plurality of action button prompts on the AI clipboard suggestion interface further comprising:
a summary action button prompt, an AI reply action button prompt and a translate action button prompt, to suggest content for the current conversation session on the computing device, at least based on a knowledge graph; and
an AI reply tone of the processed response or a predicted content for the current conversation session.

10. The system (100) as claimed in claim 8, wherein
a plurality of action button prompts on the AI clipboard suggestion interface (114) further comprising:
a summary action button prompt, an AI reply action button prompt and a translate action button prompt, to suggest content for the current conversation session on the computing device (102), at least based on a knowledge graph; and
an AI reply tone of the processed response or a predicted content for the current conversation session.
